(19) United States
(12) Patent Application Publication
(10) Pub. No.: US 2014/0076282 A1
(43) Pub. Date: Mar. 20, 2014

(54) Injection Rail

(71) Applicant: Emer S.p.A., Eufemia (IT)

(72) Inventor: Dario Bartolini, Cotignola (IT)

(21) Appl. No.: 14/082,870

(22) Filed: Nov. 18, 2013

Related U.S. Application Data
(63) Continuation of application No. PCT/IT2011/000160, filed on May 18, 2011.

(51) Int. Cl. F02M 55/02

(52) U.S. Cl. CPC F02M 55/025
USPC 123/456

(57) ABSTRACT

An injection rail for automotive systems with engine fuelled by a gas engine, especially dual-fuelled diesel-natural gas systems, comprising a main body including a gas inlet duct, a mixing chamber and a plurality of gas outlet nozzles communicating with the mixing chamber and suitable for being connected to the engine. A plurality of gas interception injectors is associated with the inlet duct. Each injector has an inlet passage communicating with the gas inlet duct and an outlet passage leading into the mixing chamber.

### CROSS-REFERENCE TO RELATED APPLICATION

This application is a continuation of International Application No. PCT/IT2011/000160 having an international filing date of May 18, 2011 entitled “Injection Rail”. The '160 international application is hereby incorporated by reference herein in its entirety.

### FIELD OF THE INVENTION

The present invention concerns an injection rail for automotive systems with an engine fuelled by a gas, especially dual-fuelled diesel-natural gas systems.

### BACKGROUND OF THE INVENTION

The application of transformation systems to automobiles that fuel the engines with gas to achieve an overall mixed fuel system is well known. Traditionally, these systems are made up of a gas tank, a pressure regulator that brings the gas to the pressure required to fuel the engine, a series of pipes and relative accessories for easy tank loading and optimum operation of the entire system and of a rail of injectors.

Injectors are essential elements of a system for engines fuelled by gaseous fuels. The injectors dispense gaseous fuel in the quantity required by the engine with sensitivity and dispensing readiness required by the engine itself.

Typically injection rails are made up of a pipe, generally with a round section that can receive various types of fuel under pressure to supply the injectors connected to the injector rails. An injector for each engine cylinder is present in each injection rail. In such configurations, the injection rail outlets correspond to the outlet of the injectors, each outlet being connected to a respective engine cylinder.

These traditional injection rails have a number of drawbacks. First, because the injector outlets are directly and individually connected to the engine, it is necessary to configure different rails for different applications, in particular according to the number of engine cylinders.

A further drawback, given that each cylinder is supplied by a respective injector, is the need for each injector to operate in the low flow rate conditions required by the engine. This means wear on all the injectors also in such low flow rate conditions.

A further drawback is tied to the fact that the minimum injectable flow rate corresponds to the minimum flow rate of each injector multiplied by the number of rail injectors. In existing dual-fuel diesel/natural gas systems the diesel fuel flow rate is very finely choked. In fact, the engine works with high efficiencies at low load efficiencies, a condition which results in minimal diesel fuel flow rates, which is in part replaced by the gaseous fuel. With existing injection rails, the minimum injectable flow rate is unfavorably high for such applications.

A final drawback of existing injector rails is that the gas flow at engine inlet is intermittent while the operation mode of the injectors is pulsing.

The present injection rail provides one or more of the following advantages:

(a) a single injection rail for different applications, in particular for motor vehicles with different numbers of engine cylinders;

(b) increase in the operating efficiency [of the injection rail] in different operating conditions, reducing injector wear and making it more uniform;

(c) increase in the operating efficiency of the engine while aiding the low injected gas flow rates for each cylinder in dual-fuel diesel natural-gas applications;

(d) a continuous flow at outlet even if the injectors operate in pulsing mode.

### SUMMARY OF THE INVENTION

Shortcomings of conventional designs are overcome with an injection rail in which the injector outlets lead into a common mixing chamber where mixing occurs of the injected gas. The injected gas is conveyed toward the engine through a plurality of outlet nozzles. The injection rail comprises a main body including a gas inlet duct, a mixing chamber and a plurality of gas outlet nozzles communicating with the mixing chamber and suitable for being connected to the engine. The gas inlet duct is associated with a plurality of gas interception injectors, which are associated with the gas inlet passage. Each injector has an inlet passage communicating with the gas inlet duct and an outlet passage leading into the mixing chamber.

Such an injection rail enables the provision of a number of injectors that does not depend upon the number of engine cylinders, which will be the same as the number of rail outlet nozzles. It is also possible to supply the engine cylinders with just one operating injector. Consequently, if the required flow rate is low, it is possible to operate just one part of the injectors, in the most disparate combinations, preserving the remaining ones. The proposed solution is particularly advantageous in dual-fuel diesel-natural gas applications, where the required diesel fuel flow rates, and consequently gas flow rates, are very low. In fact, the minimum flow rate of a single injector can be split up into several cylinders, thus obtaining a reduction factor equal to the number of the cylinders, and therefore very fine fuel choking.

It is also possible, by means of an electronic control unit which controls the injectors, to manage rail operation in such a way that the injectors have uniform wear over time.

In the mixing chamber between the outlet passages of the injectors and the outlet nozzles of the gas from the rail, the injected gas is mixed and therefore, even though the injectors have a pulsing operation, there is a continuous flow of gas at nozzle outlet towards the engine. This allows a linear operating speed to be obtained.

In one embodiment, the mixing chamber comprises a first chamber portion extending between one extremity of the inlet into which lead the outlet passages of the injectors and an outlet extremity opposite the inlet extremity, and a second chamber portion communicating with the outlet extremity of the first chamber portion and suitable for conveying the gas coming from the first chamber portion towards gas outlet nozzles. The two chamber portions are therefore obtained consecutively with respect to the direction of gas flow from the injector outlet passages to the outlet nozzles. Advantageously, the first chamber portion is configured to carry out the actual mixing function of the gas injected by the injectors; the second chamber portion is configured to mainly perform a distribution or conveying function of the gas flow coming from the first chamber portion towards the outlet nozzles in a uniform way.

In order to obtain a perfect mix and distribution, the volume of the first chamber portion is reduced in a substantially gradual way from the inlet extremity to the outlet extremity. In some embodiments, the first chamber portion has a substantially truncated-cone or funnel shape.

In one embodiment, in which the mixing chamber has a substantially truncated-cone, or funnel shape, and extends between a larger base and a smaller base, the injectors are coplanar to one another and have the respective outlet passages open in the larger base.

In one embodiment, the main body of the injection rail has a prismatic shape having two opposite bases and a side wall extending around a main axis of the body. The two chamber portions can be coaxial to each other and extend around the main axis of the main body.

In such a rail structure, the injectors are supported by or housed in one of the two opposite bases of the main prismatic body and the outlet passages of the injectors are positioned parallel to the main axis of the main body. In this embodiment, the gas inlet duct extends below the injectors, along a perpendicular direction with respect to the main axis. For example, the gas inlet duct can be a rectilinear duct open on the side surface of the main body.

An effective and uniform distribution of the gas flow to the outlet nozzles is achieved with a second chamber portion that mainly extends in a radial direction with respect to the main axis of the main body. In other words, the second chamber portion has a reduced axial depth so the gas from the first chamber portion with an axial direction is distributed uniformly in the second chamber portion, reaching in particular the side wall which defines the second mixing chamber portion. Advantageously, then, the outlet nozzles are obtained radial with respect to the main axis, so they are open in the side wall that delimits the second chamber portion, and in particular they are coplanar with one another and are distributed along the side wall of the main body.

### BRIEF DESCRIPTION OF THE DRAWINGS

FIG. 1 is a plan view from above the injection rail, with four housed injectors.

FIG. 2 is a front elevation view of the injection rail.

FIG. 3 is a side elevation view of the rail.

FIG. 4 is an axial section of the rail along the line B-B of FIG. 2.

FIG. 5 is an axial section of the rail along the line A-A of FIG. 1.

FIG. 6 shows a table of the outlet capacity values according to the injected capacity.

### DETAILED DESCRIPTION OF PREFERRED EMBODIMENT(S)

In the drawings, reference numeral 100 refers to an injection rail for automotive systems with engine fuelled by a gas, particularly dual-fuel diesel-natural gas systems. The injection rail 100 comprises a main body 1 including an inlet duct 16 of a gas, a mixing chamber 18, 21, 22, 23 and a plurality of outlet nozzles 6 of the gas communicating with the mixing chamber and suitable for being connected to the engine.

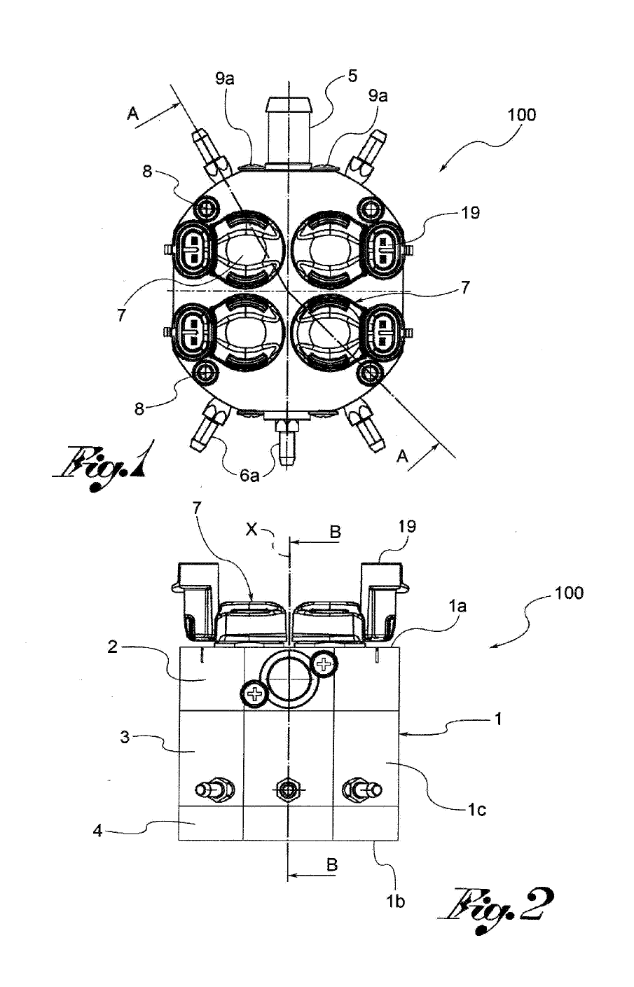

As shown in FIGS. 1-5, main body 1 has a prismatic shape made up of two opposite bases la, lb and a side wall 1c extending around a main axis X of the body 1. Main body 1 includes three portions: an injector-carrying extremity portion 2, as shown in FIG. 2, at the top of main body 1. Main body 1 also comprises an intermediate nozzle-carrying portion 3, and a lower portion or cover 4. The three portions of the body 2, 3, 4 are assembled in sandwich fashion by fasteners, shown in FIG. 1 as screws 8.

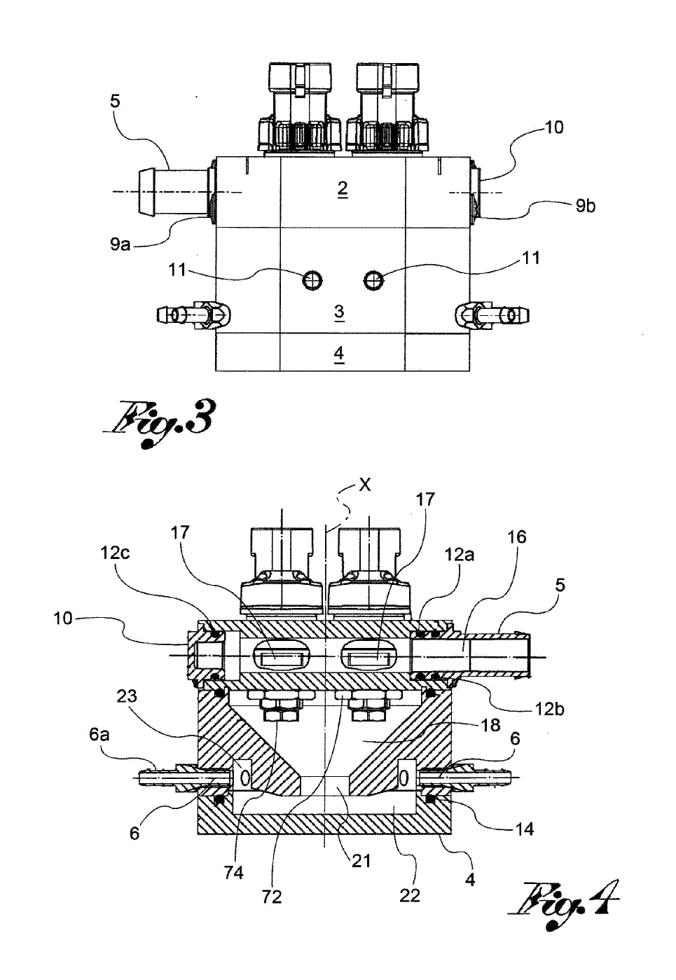

The injector-carrying section 2 can be a single piece housing a plurality of injectors 7 for intercepting the flow of gas associated with the gas inlet duct 16. (See FIG. 3).

Injectors 7, as shown in FIG. 1, are of the electromagnetic-control type, but other type of injectors can also be used. Each of injectors 7 is essentially a valve comprising an injector body defining an inlet chamber with an inlet passage 17 in fluid communication with a gas inlet duct 16 and an outlet passage 74 leading into the common mixing chamber 18 of the rail and a valve seat at the mouth of the outlet duct between the inlet chamber and outlet passage 74. A valve shutter, shown in FIG. 1 as a disc formed of ferromagnetic material, is opened and closed by an electromagnet, thereby moving the valve seat from a closed position to an open position to alternatingly block or allow the flow of gaseous fuel from inlet passage 17 to outlet passage 74 of injector 7. An example of such electromagnetic-control injector is described in Italian Patent Publication No. 1368477.

The injector-carrying portion 2 also comprises, perpendicularly to the main axis X, the gas inlet duct 16 which can be connected via hose connector 5, to an upstream device (not shown), such as a pressure regulator. Hose connector 5 is fastened to injector-carrying portion 2 by means of screws 9a (see FIG. 1) and seal gaskets 12a and 12b (see FIG. 4), which are placed between hose connector 5 and body portion 2.

Gas inlet duct 16 is closed on the opposite side from hose connector 5 by a cap 10 fastened to body portion 2 by means of screws 9b (see FIG. 3). Seal gasket 12c (see FIG. 4) is placed between cap 10 and the body.

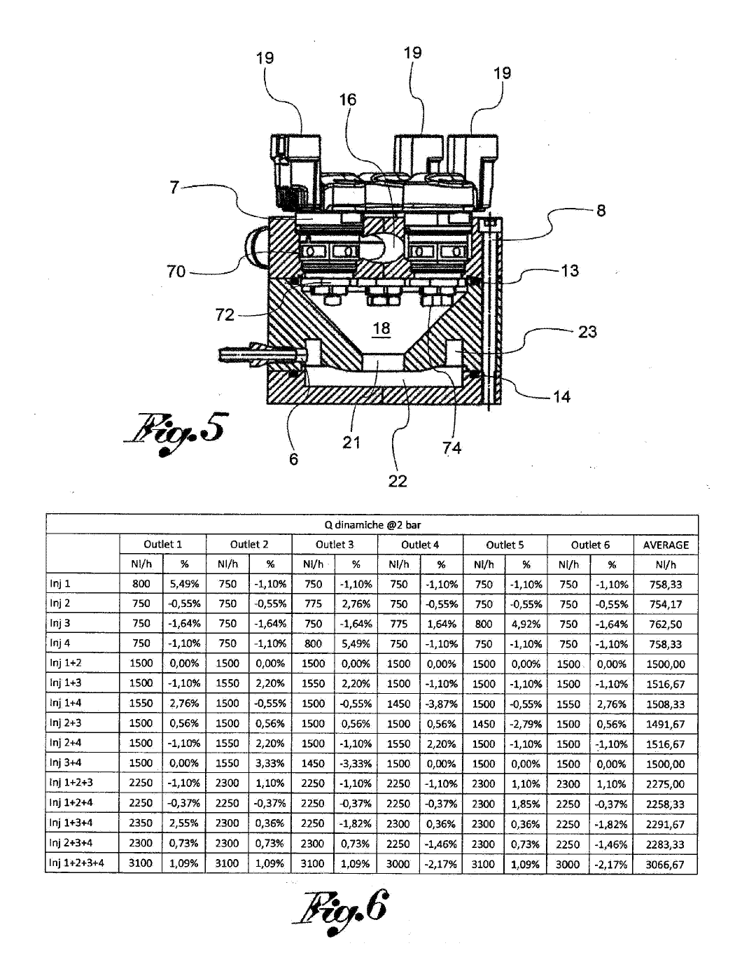

Turning to FIG. 5, injector-carrying body portion 2 (see FIG. 3) comprises cylindrical seats 70 housing injectors 7 so the inlet passage of each connector is fluidly connected to gas inlet duct 16, outlet passage 74 of each injector is open in the mixing chamber, and electric connector 19 of each injector is turned towards the outside of main body 1.

In the embodiment shown, injection rail 100 has four injectors 7, arranged in opposite pairs. Each cylindrical seat 70 crosses the portion of injector-carrying body 2 communicating below with mixing chamber 18. Each injector 7 is fitted in the respective cylindrical seat 70 with the interposition of sealing O-rings and is fastened to the injector-carrying body 2 for example by means of a fastening ring nut 72, which is screwed onto a threaded portion of the injector body protruding below from the body portion 2 and overhanging in the mixing chamber 18.

Injector-carrying portion 2 closes mixing chamber 18 at the top and can be easily screwed onto fastening ring nut 72 before injector-carrying portion 2 is coupled with nozzle-carrying portion 3.

Nozzle-carrying portion 3 (see FIG. 3) is preferably made in a single piece defining a first portion 18 of the mixing chamber. First chamber portion 18 has a substantially truncated-cone or funnel shape coaxial with main axis X and narrows towards the extremity turned towards lower cover 4. Consequently, outlet passages 74 of injectors 7 are open on the larger base of first portion 18 of the mixing chamber. Correct mixing and uniform distribution of the injected gas have been found with a ratio between the diameters of the larger base and of the smaller base of the truncated-cone shaped mixing chamber between injector-carrying portion 2 and injectors 7.

Gas outlet nozzles 6 are also retained in nozzle-carrying portion 3. More precisely, outlet nozzles 6 are retained in the side wall of nozzle-carrying body 3 and extend in a radial way with respect to main axis X of body 1. Hose connections 6a for connection to the engine are mounted, as example, by screwing, on outlet nozzles 6.

Nozzle-carrying body 3 is fastened to body 2 by means of four screws 8 and with the interposition of a seal gasket 13. First chamber portion 18 is open at the bottom onto an intermediate duct 21, preferably with constant section, leading in turn into a second chamber portion 22. The latter extends around main axis X and has a prevalently radial extension with respect to the axis, meaning it has a limited depth in axial direction, lower for example than the depth of first chamber portion 18. Second chamber portion 22 is contained mainly in lower cover 4 and is closed at the top by the base of nozzle-carrying body 3.

In other words, second chamber portion 22 is defined by the coupling of nozzle-carrying body 3 to lower cover 4 by means of four screws 8 and with the interposition of a seal gasket 14.

Second chamber portion 22 comprises an annular appendix 23 contained in the lower part of nozzle-carrying body 3 coaxially to main axis X and open towards lower cover 4. Outlet nozzles 6 lead into annular appendix 23.

The second chamber portion 22 performs the function of distributing or conveying, in a uniform way towards the outlet nozzles 6, the flow of combustible gas coming from the first chamber portion 18 through the intermediate duct 21.

Lower cover 4 can be advantageously made in a single piece.

Advantageously, a pressure sensor and/or a temperature sensor (not shown) can be mounted on the injection rail.

Finally, main body 1 has threaded holes 11 intended for coupling with a fastening bracket on the vehicle.

From the illustration, it can be appreciated how the injection rail is much more compact with respect to traditional injection rails wherein the injectors are arranged in line along an inlet duct.

The combustible gas thus enters the rail through hose connection 5 and runs along inlet duct 15 which is in fluid connection with the injector inlet passages. The injector outlets are located inside truncated-cone chamber 18, which allows for mixing of the gas and which is in communication, through short intermediate duct 21, with distribution chamber 22. The gas is then conveyed towards the engine through outlet nozzles 6. The path the gas is forced to follow from injector outlet to nozzles allows obtaining, at the outlet of nozzles 6, a continuous and uniform flow quite apart from the number of injectors in operation.

The table at FIG. 6 underscores the effectiveness of the redistribution of the flow injected into a rail housing four injectors and six outlet nozzles. The flow values shown refer to the following operating conditions:

temperature of 25±1° C.,

relative pressure of 2±0.05 Bar;

ambient pressure of 1±0.02 Bar;

power voltage 12.5±0.1 V;

frequency of 8000 rpm;

pulse amplitude of 7 msec.

The table shows the flow values at outlet from each nozzle (in Normal liters per hour, “Nl/h”) for each possible injector operating condition. The percentage values indicate the deviation between the flow at nozzle outlet and the average flow that would be obtained with an ideal mix/distribution. In each case, a low deviation is achieved through the geometry and arrangement of the chambers and ducts inside the device.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. An injection rail comprising:
(a) a main body comprising:
(i) a gas inlet duct,
(ii) a mixing chamber and
(iii) a plurality of gas outlet nozzles communicating with said mixing chamber and suitable for connecting to an engine; and
(b) a plurality of gas interception injectors, each of said gas interception injectors having an inlet passage communicating with said gas inlet duct and an outlet passage for directing gas into said mixing chamber.

2. The injection rail of claim 1, wherein said intercepting injectors are electro-magnetically controlled.

3. The injection rail of claim 1, wherein said mixing chamber comprises a first chamber portion extending between one extremity of said inlet into which lead said outlet passages of said injectors and an outlet extremity opposite said inlet extremity, and a second chamber portion communicating with said outlet extremity of the first chamber portion and suitable for conveying a gas coming from said first chamber portion towards said gas outlet nozzles.

4. The injection rail of claim 3, wherein the volume of said first chamber portion is reduced in a substantially gradual way from said inlet extremity to said outlet extremity.

5. The injection rail of claim 4, wherein said first chamber portion has a substantially truncated-cone shape.

6. The injection rail of claim 5, wherein said injectors are coplanar to each other and the respective outlet passages open in the larger base of said first truncated-cone chamber portion.

7. The injection rail of claim 3, wherein said two chamber portions are coaxial with one another and extend around a main axis of said main body.

8. The injection rail of claim 1, wherein said gas inlet duct is obtained perpendicular with respect to said main axis and is open on the side wall of said main body.

9. The injection rail of claim 8, wherein said injector outlet passages are positioned parallel to the main axis of said main body.

10. The injection rail of claim 3, wherein said second chamber portion extends mainly in a radial direction with respect to the main axis of said main body.

11. The injection rail of claim 10, wherein said gas outlet nozzles are positioned in a radial direction with respect to said main axis.

12. The injection rail of claim 11, wherein said outlet nozzles are coplanar with one another and are distributed along the side wall of said main body.

13. The injection rail of claim 3, wherein said two portions of said mixing chamber communicate with each other through an intermediate duct with constant section.

14. The injection rail of claim 5, wherein the ratio between the diameters of said larger base and of said smaller base of said truncated-cone mixing chamber is between 2 and 7.

15. The injection rail of claim 1, wherein the number of injectors is between 2 and 6.

16. The injection rail of claim 1, wherein the number of gas outlet nozzles is between 4 and 8.

17. The injection rail of claim 1, wherein a temperature sensor is fitted on said injection rail.

18. The injection rail of claim 1, wherein a pressure sensor is fitted on said injection rail.

19. The injection rail of claim 1, wherein a pressure and temperature sensor is fitted on said injection rail.
